(19) United States
(12) Patent Application Publication
(10) Pub. No.: US 2026/0322844 A1
(43) Pub. Date: Oct. 15, 2026

(54) METHOD AND SYSTEM FOR AUTOMATED TRANSFER OF VULNERABILITY DETECTION TO CONTENT DISARM AND RECONSTRUCTION RULES

(71) Applicant: ARIEL SCIENTIFIC INNOVATIONS LTD., Ariel (IL)

(72) Inventor: Ran DUBIN, Ariel (IL)

(21) Appl. No.: 19/113,637

(22) PCT Filed: Sep. 21, 2023
(86) PCT No.: PCT/IL2023/051024

§ 371 Date: Mar. 20, 2025

Related U.S. Application Data
(60) Provisional application No. 63/408,631, filed on Sep. 21, 2022.

(51) Int. Cl. H04L 9/40; G06F 21/57

(52) U.S. Cl. CPC H04L 63/1433; G06F 21/577

(57) ABSTRACT

The present invention relates generally to systems and methods of cyber security. More specifically, the present invention relates to automated transfer of vulnerability detection to content disarm and reconstruction rules, for mitigating cyberattacks. In the general aspect, the invention may be directed to a method and a system of mitigating cyber vulnerabilities by at least one processor, the method including receiving a detection rule, representing a known cyber vulnerability associated with a specific data structure type; parsing the detection rule, to produce a generic representation of the detection rule; and based on the generic representation and the specific data structure type, creating a disarm rule for mitigating the cyber vulnerability in incoming data structures of the specific data structure type.

### CROSS-REFERENCE TO RELATED APPLICATIONS

This application claims the benefit of priority of U.S. Patent Application No. 63/408,631, filed 21 Sep. 2022, and titled: “METHOD AND SYSTEM FOR AUTOMATED TRANSFER OF VULNERABILITY DETECTION TO CONTENT DISARM AND RECONSTRUCTION RULES”, which are hereby incorporated by reference in their entirety.

### FIELD OF THE INVENTION

The present invention relates generally to systems and methods of cyber security. More specifically, the present invention relates to automated transfer of vulnerability detection to content disarm and reconstruction rules, for mitigating cyberattacks.

### BACKGROUND OF THE INVENTION

As known, information technology security or cybersecurity has become an imperative aspect of contemporary computer systems and networks, as well as for the ubiquitous implementation of smart devices, including smartphones, televisions, and various devices that constitute the Internet of things (IoT) technology. In practice, such systems, devices and networks continue to be vulnerable to cyberattacks. A cyberattack is a deliberate attempt to access data, functions, or other restricted areas of the system without authorization, potentially with malicious intent. Cyberattacks may steal, alter, or destroy target information by hacking into susceptible systems. As a result of cyberattacks, confidentiality, integrity or availability of target resources may be compromised. Moreover, the damage may extend to resources in addition to the one initially identified as vulnerable, including, e.g., further resources of the organization that owns the initial resource, and the resources of other involved parties (customers, suppliers). Eventually, cyberattacks have become increasingly sophisticated and dangerous.

Even though many approaches and techniques of cyberattack prevention are known from the prior art nowadays, the technological field of information security remains constantly evolving, struggling to challenge with rapidly developing malware.

For example, currently available Content Disarm and Reconstruction (CDR) technology is a computer security technology for removing potentially malicious code from files. Unlike malware analysis technology, CDR technology does not determine or detect malware functionality but removes all file components that are not approved within a system's definitions and policies. CDR provides true “zero-day” prevention, while delivering files to users quickly.

However, not all cyberattacks are related to the file structure or the file capabilities such as macros, JavaScript, embedded object, etc. For example, some advance exploits aim to attack program modules that read or utilize the content of compromised files (e.g., FileReader object), for instance, by trying to create buffer overflow. Other exploits may be related to the parts of file structure, with respect to which the CDR prevention algorithm is unaware that these parts may be used for a cyberattack.

Computer security solutions which utilize malware analysis technology provide protection patching since in order to keep these solutions effective against new cyberattacks they must be eventually modified and updated. It takes time to develop, test, and validate additional dedicated features before releasing them to a production environment. Consequently, there is a time gap between appearance of a cyberattack of a new type and a respective update to computer security solution, which makes such solutions ineffective in respect of time-critical protection.

### SUMMARY OF THE INVENTION

Accordingly, there is a need for a system and method of mitigating cyber vulnerabilities which would provide improved technical effect of increasing protection against cyberattacks. In particular, the purpose of the claimed invention is to make a computer security solution which provides more vulnerability-specific protection than conventional CDR solutions on the one hand and more time-critical protection than conventional malware-analysis-based solutions on the other hand.

To overcome the shortcomings of the prior art, the following invention is provided.

In the general aspect, the invention may be directed to a method of mitigating cyber vulnerabilities by at least one processor. The method may include receiving a detection rule, representing a known cyber vulnerability associated with a specific data structure type; parsing the detection rule, to produce a generic representation of the detection rule; and based on the generic representation and the specific data structure type, creating a disarm rule for mitigating the cyber vulnerability in incoming data structures of the specific data structure type.

In another general aspect, the invention may be directed to a method of mitigating cyber vulnerabilities by at least one processor, the method including receiving a target data structure of a specific data structure type; receiving a detection rule, representing a known cyber vulnerability associated with the specific data structure type; based on the detection rule, detecting at least one portion of the target data structure that comprises an instantiation of the known cyber vulnerability; creating a detected vulnerability map representing an interconnection between the detected portion and at least one section and/or element of the data structure, related to the detected portion; based on said detected vulnerability map, applying an omission action on the target data structure, to omit the detected portion and the at least one section and/or element, thus obtaining a disarmed data structure.

In yet another general aspect, the invention may be directed to a system for mitigating cyber vulnerabilities, the system including a non-transitory memory device, wherein modules of instruction code are stored, and at least one processor associated with the memory device, and configured to execute the modules of instruction code, whereupon execution of said modules of instruction code, the at least one processor is configured to receive a detection rule, representing a known cyber vulnerability associated with a specific data structure type; parse the detection rule, to produce a generic representation of the detection rule; and based on the generic representation and the specific data structure type, create a disarm rule for mitigating the cyber vulnerability in incoming data structures of the specific data structure type.

In some embodiments, said disarm rule includes an association between (a) an instantiation of the known cyber vulnerability in a data structure of the specific data structure type, and (b) at least one omission action, required for omitting at least one portion of the data structure, wherein said portion comprises the known cyber vulnerability.

In some embodiments, the method further includes receiving a target data structure of the specific data structure type; and applying the omission action on the target data structure, to omit said portion, thus obtaining a disarmed data structure.

In some embodiments, the method further includes receiving a target data structure of the specific data structure type; applying the detection rule, to detect at least one portion of the target data structure that comprises the instantiation of the known cyber vulnerability; creating a detected vulnerability map representing an interconnection between the detected portion and at least one section and/or element of the data structure, related to the detected portion; based on said detected vulnerability map, applying the omission action on the target data structure, to omit the detected portion, thus obtaining a disarmed data structure.

In some embodiments, the omission action further comprises omission of at least one section and/or element of the data structure, related to the detected portion; and/or at least one reference to said section or element.

In some embodiments, the method further includes creating a reconstruction rule based on the generic representation and the specific data structure type, wherein said reconstruction rule includes an association between (a) location of an instantiation of the known cyber vulnerability in a data structure of the specific data structure type, and (b) at least one reconstruction action, required for maintaining a predefined functionality of the data structure following omission of the known cyber vulnerability from the data structure.

In some embodiments, the method further includes applying the reconstruction action on the disarmed data structure, to maintain the predefined functionality of the target data structure.

In some embodiments, the data structure is selected from a list consisting of a file, a data stream, a string representing an Application Programming Interface (API) request, and a string representing an API response.

In some embodiments, the detection rule is of a first type of a plurality of detection rule types, and parsing the detection rule includes producing a generic representation that is common to (i) the first type and (ii) at least one second type of the plurality of detection rule types.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram, depicting a computing device which may be included in the system for mitigating cyber vulnerabilities according to some embodiments.

FIG. 2A is a block diagram, depicting a system for mitigating cyber vulnerabilities, according to some embodiments;

FIG. 2B is a block diagram, depicting a system for mitigating cyber vulnerabilities, according to alternative embodiments;

FIG. 3A is a flow diagram, depicting a method of mitigating cyber vulnerabilities, according to some embodiments; and

FIG. 3B is a flow diagram, depicting a method of mitigating cyber vulnerabilities, according to alternative embodiments.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

Unless explicitly stated, the method embodiments described herein are not constrained to a particular order or sequence. Additionally, some of the described method embodiments or elements thereof can occur or be performed simultaneously, at the same point in time, or concurrently.

In some respects, the following description of the claimed invention is provided in accordance with the task of mitigating cyber vulnerabilities in incoming data structures of specific data structure type, wherein the data structure is a file. Such a specific embodiment is provided in order for the description to be sufficiently illustrative and it is not intended to limit the scope of protection claimed by the invention. It should be understood for the one ordinary skilled in the art that the implementation of the claimed invention in accordance with such a task is provided as a non-exclusive example and other practical implementations can be covered by the claimed invention.

Hence, in alternative implementations, data structure may be a data stream, or a string representing an Application Programming Interface (API) request, or a string representing an API response etc.

As known in the art, detecting new cyberattacks and vulnerabilities is a significant effort that business entities, security companies, and governments are working on together, trying to stop new cyberattacks as fast as possible from the moment they are detected. In order to do that, security experts create so-called detection rules such as Yara, Sigma, Suricata, Snort etc., which can be shared, for example, by different online resources. Such rules are aimed at helping malware researchers to identify and classify malware samples. The rules include descriptions of malware families based on textual or binary patterns. Each description, a.k.a. rule, usually consists of a set of strings and a Boolean expression which determines its logic. As further described in detail herein, the claimed technical effect is provided by transformation of such detection rules into prevention actions which is done by the claimed system according to the claimed method.

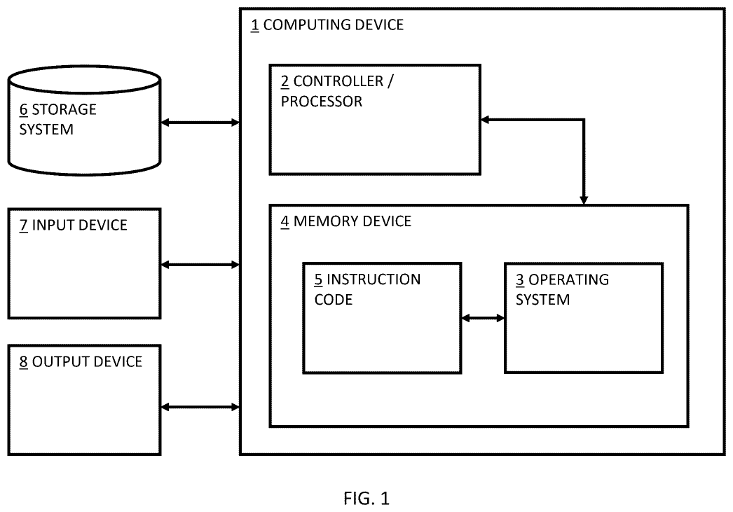

Reference is now made to FIG. 1, which is a block diagram depicting a computing device, which may be included within an embodiment of a system for mitigating cyber vulnerabilities, according to some embodiments.

Computing device 1 may include processor or controller 2 that may be, for example, a central processing unit (CPU) processor, a chip or any suitable computing or computational device, operating system 3, memory device 4, instruction code 5, storage system 6, input devices 7 and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to instruction code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory device 4 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short-term memory unit, a long term memory unit, or other suitable memory units or storage units. Memory device 4 may be or may include a plurality of possibly different memory units. Memory device 4 may be a computer or processor non-transitory readable medium, or a computer non-transitory storage medium, e.g., a RAM. In one embodiment, a non-transitory storage medium such as memory device 4, a hard disk drive, another storage device, etc. may store instructions or code which when executed by a processor may cause the processor to carry out methods as described herein.

Instruction code 5 may be any executable code, e.g., an application, a program, a process, task, or script. Instruction code 5 may be executed by processor or controller 2 possibly under control of operating system 3. For example, instruction code 5 may be an application that mitigate cyber vulnerabilities as further described herein. Although, for the sake of clarity, a single item of instruction code 5 is shown in FIG. 1, a system according to some embodiments of the invention may include a plurality of executable code segments or modules similar to instruction code 5 that may be loaded into memory device 4 and cause processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Various types of input and output data may be stored in storage system 6 and may be loaded from storage system 6 into memory device 4 where it may be processed by processor or controller 2. In some embodiments, some of the components shown in FIG. 1 may be omitted. For example, memory device 4 may be a non-volatile memory having the storage capacity of storage system 6. Accordingly, although shown as a separate component, storage system 6 may be embedded or included in memory device 4.

Input devices 7 may be or may include any suitable input devices, components, or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

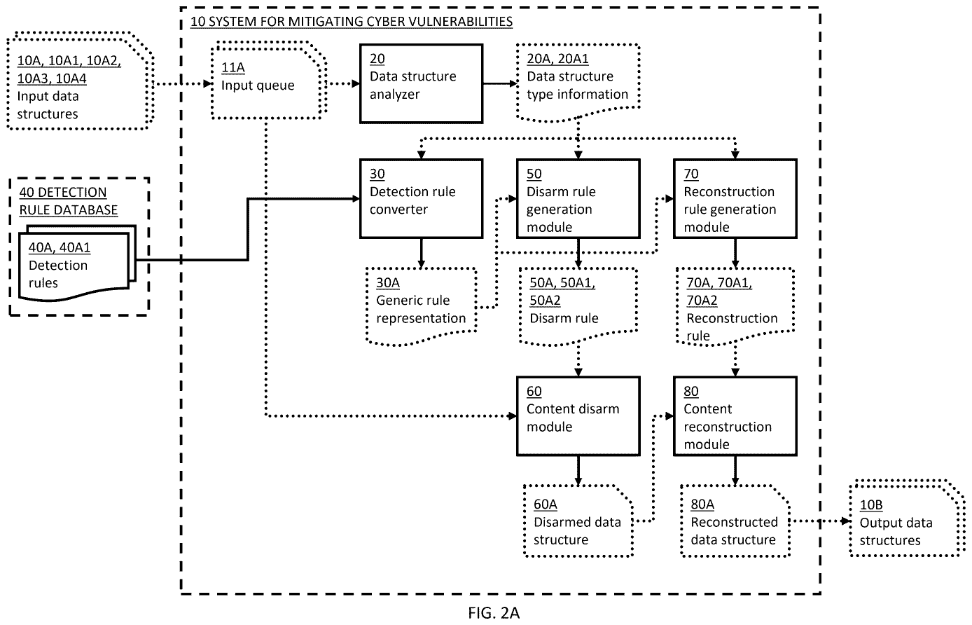

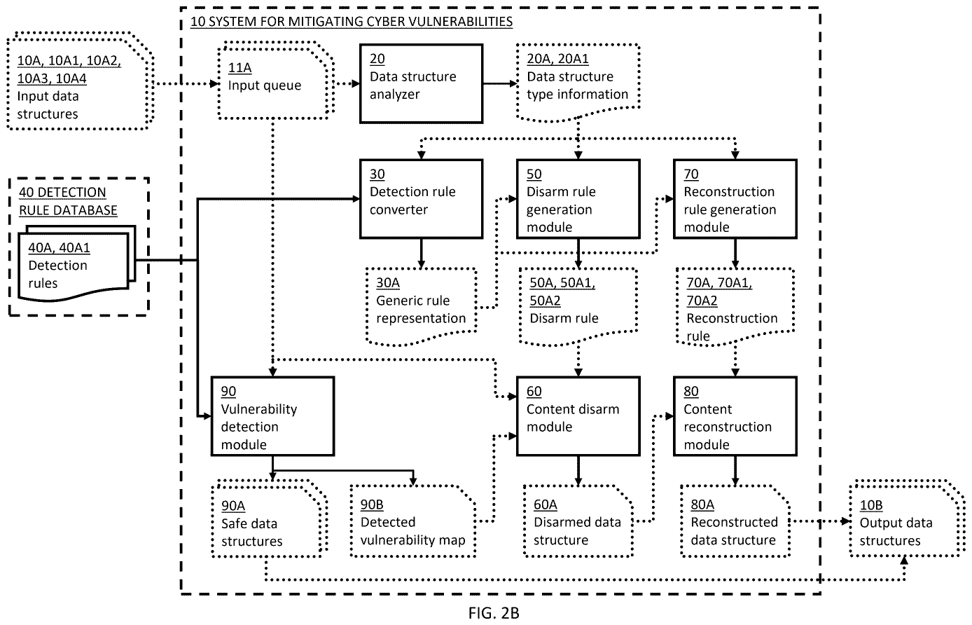

Reference is now made to FIG. 2A, which is a block diagram, depicting a system 10 for mitigating cyber vulnerabilities, according to some embodiments.

According to some embodiments of the invention, system 10 may be implemented as a software module, a hardware module, or any combination thereof. For example, system 10 may be or may include a computing device such as element 1 of FIG. 1. Alternatively, system 10 may be or may include a separate program product, application or API module. Furthermore, system 10 may be adapted to execute one or more modules of instruction code (e.g., element 5 of FIG. 1) to request, receive, analyze, calculate and produce various data in order to mitigate cyber vulnerabilities, as further described in detail herein.

As shown in FIGS. 2A and 2B, arrows may represent flow of one or more data elements to and/or from system 10, and/or among modules or elements of system 10. Some arrows have been omitted in FIG. 2 for the purpose of clarity.

In some embodiments, system 10 may include data structure analyzer 20 and detection rule converter 30, which may be implemented as the modules of instruction code (e.g., similar to instruction code 5).

In some embodiments, system 10 may be configured to receive input (target) data structure 10A (e.g., a file) of specific data structure type 20A1 (e.g., .doc, .pdf format, etc.). System 10 may be further configured to form input queue 11A from received input data structures 10A, e.g., placing them in order of appearance. Data structure analyzer 20 may be configured to receive input data structure 10A from input queue 11A, analyze it and form data structure type information 20A about received data structure 10A (e.g., information describing file sections present in the .pdf file, their interconnection and content, such as image, text, metadata etc.).

In some embodiments, detection rule converter 30 may be configured to receive data structure type information 20A. Detection rule converter 30 may be further configured to request at least one detection rule of detection rules 40A, representing known cyber vulnerability 40A1 associated with specific data structure type 20A1, defined by data structure type information 20A. Detection rules 40A may be provided by third-party detection rule database 40. In some embodiments, detection rules 40A may be selected from a plurality of detection rule types, such as Yara, Sigma, Suricata, Snort etc., which are known from the prior art. Detection rules 40A may include various combinations of hexadecimal strings, text strings, regular expressions, arithmetic actions, and may be configured to be used with different content decoders.

Detection rule converter 30 may be further configured to receive at least one detection rule of detection rules 40A, parse received detection rule and produce generic representation 30A of detection rule. In some particular examples, generic representation 30A may be such a representation that has a format common to the abovementioned detection rule types (e.g., Yara, Sigma, Suricata, Snort, and the like). In other words, detection rule converter 30 may be configured to map, or parse various detection rules of various format languages and syntaxes per type. Detection rule converter 30 may thus provide generic representation 30A as a universal way of performing the following disarming actions independently of the differences in detection rules syntax and format.

In some embodiments, system 10 may further include the following modules of instruction code (e.g., similar to instruction code 5): disarm rule generation module 50 and content disarm module 60.

In some embodiments, disarm rule generation module 50 may be configured to receive data structure type information 20A of data structure 10A from input queue 11A and generic representation 30A of respective detection rule. Disarm rule generation module 50 may be further configured to create disarm rule 50A based on generic representation 30A and data structure type 20A1 specified by received data structure type information 20A. Disarm rule 50A may include an association between (a) instantiation 50A1 of known cyber vulnerability 40A1 in a data structure (e.g., in data structure 10A from input queue 11A) of specific data structure type 20A1 (e.g., defined by data structure type information 20A), and (b) at least one omission action 50A2, required for omitting at least one portion 10A1 of the data structure, wherein said portion 10A1 comprises known cyber vulnerability 40A1.

For example, omission action 50A2 may include omission of a specific keyword located in specific section 10A2 of data structure 10A of specific data structure type 20A1. In another example, omission action 50A2 may include a definition for omission of one or more sections 10A2 of data structure 10A.

In some embodiments, content disarm module 60 may be configured to receive data structures 10A from input queue 11A and respective disarm rules 50A. Content disarm module 60 may be further configured to mitigate cyber vulnerabilities in incoming data structure (e.g., in data structure 10A from input queue 11A) of specific data structure type 20A1 (e.g., defined by data structure type information 20A). In particular, content disarm module 60 may be further configured to apply omission action 50A2 of disarm rule 50A on data structure 10A from input queue 11A, to omit portion 10A1 of data structure 10A including respective known cyber vulnerability 40A1. Content disarm module 60 may be further configured to output disarmed data structure 60A.

In some embodiments, system 10 may further include the following modules of instruction code (e.g., similar to instruction code 5): reconstruction rule generation module 70 and content reconstruction module 80.

In some embodiments, reconstruction rule generation module 70 may be configured to receive data structure type information 20A of data structure 10A from input queue 11A and generic representation 30A of respective detection rule. Reconstruction rule generation module 70 may be further configured to create reconstruction rule 70A based on received generic representation 30A and data structure type 20A1 specified by received data structure type information 20A. Reconstruction rule 70A may include an association between (a) location 70A1 of instantiation 50A1 of known cyber vulnerability 40A1 in a data structure (e.g., in data structure 10A from input queue 11A) of specific data structure type (e.g., data structure type 20A1 defined by data structure type information 20A), and (b) at least one reconstruction action 70A2, required for maintaining a predefined functionality of the data structure following omission of known cyber vulnerability 40A1 from the data structure.

For example, data structure 10A may be a .pdf file that may include a body section and a header section, wherein header section includes image having known cyber vulnerability 40A1. For such case, reconstruction action 70A2 may include replacing the existing header section with a template header section, for example including text message informing a user that this section was replaced in order to disarm potentially malicious content.

In some embodiments, content reconstruction module 80 may be configured to receive reconstruction rule 70A and respective disarmed data structure 60A. Content reconstruction module 80 may be further configured to apply reconstruction action 70A2 of reconstruction rule 70A on disarmed data structure 60A, to maintain the predefined functionality of the target data structure (e.g., respective data structure 10A from input queue 11A). Content reconstruction module 80 may be further configured to output reconstructed data structure 80A.

System 10 may be further configured to output reconstructed data structures 80A as output data structures 10B.

Reference is now made to FIG. 2B, which is a block diagram, depicting a system 10 for mitigating cyber vulnerabilities, according to alternative embodiments.

Embodiments represented in FIG. 2B are similar in general aspects to embodiments represented in FIGS. 2A, except for the further described aspects.

Embodiments represented in FIG. 2B provide preliminary detection and analysis of instantiations of known cyber vulnerabilities in input data structures (e.g., data structures 10A from input queue 11A). Such detection and analysis provide the ability to perform omission actions with respect to minimum reasonable amount of data and thus reduce risks of irrevocably corrupting data structures.

In some embodiments, system 10 may further include vulnerability detection module 90 (e.g., implemented as module of instruction code similar to instruction code 5). Vulnerability detection module 90 may be configured to receive data structures 10A from input queue 11A and detection rules 40A representing known cyber vulnerabilities associated with the data structure types of the respective data structures (same detection rules 40A as requested by detection rule converter 30 for specific data structure 10A from input queue 11A). With respect to each received data structure 10A, vulnerability detection module 90 may be further configured to apply respective detection rule 40A, to detect a portion of the data structure (e.g., portion 10A1 of data structure 10A from input queue 11A) that includes instantiation 50A1 of respective known cyber vulnerability 40A1.

Vulnerability detection module 90 may be further configured to create detected vulnerability map 90B representing interconnection between detected portion 10A1 and at least one section 10A2 and/or element 10A3 of the data structure (e.g., of data structure 10A from input queue 11A), related to detected portion 10A1. For example, detected vulnerability map 90B may include additional information of the structure of detected vulnerability and its relation to data structure 10A. Such additional information may include specific detected keyword which is suspected to include instantiation 50A1 of known cyber vulnerability 40A1, information about the location of the keyword, information about various accompanying data, references to the detected keyword throughout data structure 10A etc.

In some embodiments, detection rule 40A may represent several interconnected known cyber vulnerabilities 40A1. In such embodiments, detected vulnerability map 90B may include additional information of the structure of each detected vulnerability 40A1 of detection rule 40A, considering their interconnection, and their relation to data structure 10A. In case only part of interconnected vulnerabilities 40A1 are detected in data structure 10A, detected vulnerability map may include information regarding only the detected part accordingly.

Vulnerability detection module 90 may be further configured to label data structure 10A as a potentially safe, in case there is no portion that includes instantiation 50A1 of respective known cyber vulnerability 40A1 detected in data structure 10A, and, accordingly, output safe data structures 90A.

Content disarm module 60 may be further configured to receive data structures 10A from input queue 11A, respective disarm rule 50A and detected vulnerability map 90B.

Based on detected vulnerability map 90B, content disarm module 60 may be configured to analyze whether it is sufficient to omit only the keyword which is suspected to include instantiation 50A1 of known cyber vulnerability 40A1, or the entire related content (e.g., entire section 10A2 of data structure 10A, references 10A4 to the keyword etc.) should be omitted in order to disarm potentially malicious content.

Content disarm module 60 may be further configured to apply, based on said detected vulnerability map 90B, omission action 50A2 of disarm rule 50A on the target data structure (e.g., data structure 10A from input queue 11A), to omit the determined sufficient amount of data. Such sufficient amount of data may include, e.g., portion 10A1 of data structure 10A that includes instantiation 50A1 of respective known cyber vulnerability 40A1, corresponding section 10A2 and/or element 10A3 of data structure 10A, related to detected portion 10A1, at least one reference 10A4 to said section 10A2, element 10A3 or portion 10A1, etc. Content disarm module 60 may be further configured to output respective disarmed data structure (e.g., disarmed data structure 60A).

System 10 may be further configured to include safe data structures 90A in output data structures 10B, in addition to reconstructed data structures 80A.

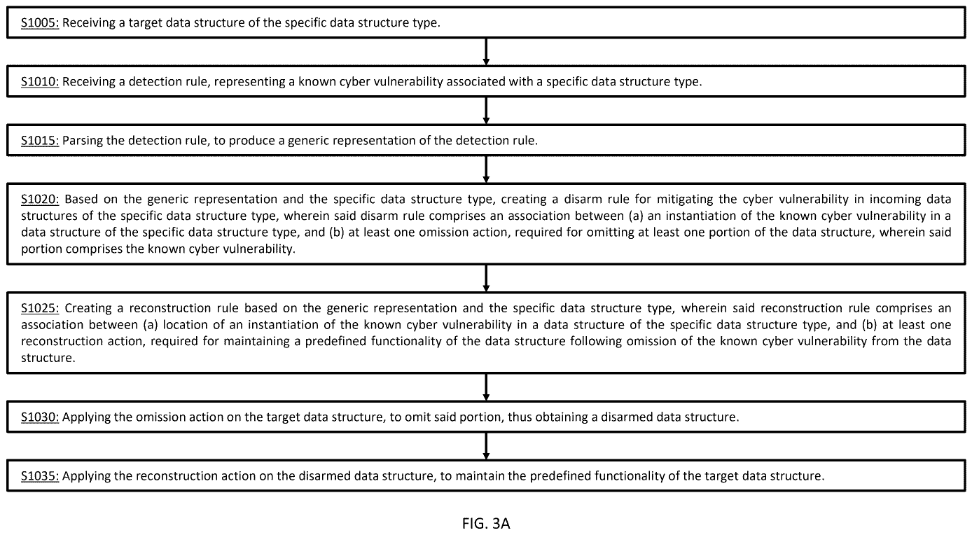

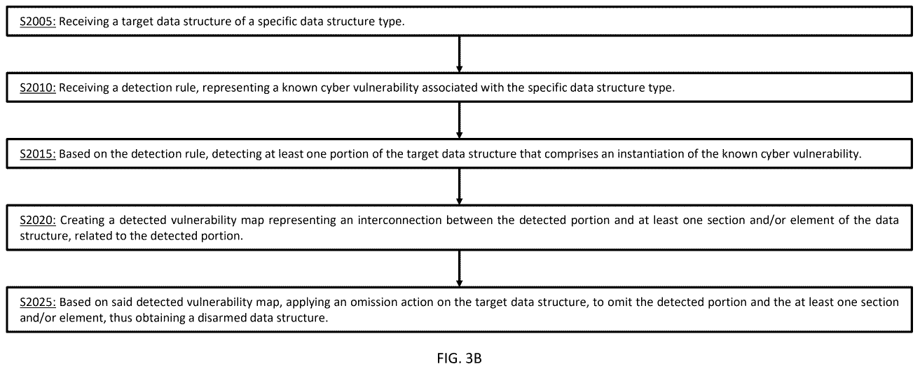

Referring now to FIG. 3A, a flow diagram is presented, depicting a method of mitigating cyber vulnerabilities, by at least one processor, according to some embodiments.

As shown in step S1005, the at least one processor (e.g., processor 2 of FIG. 1) may perform receiving a target data structure (e.g., input data structure 10A) of the specific data structure type (e.g., data structure type 20A1). Step S1005 may be carried out by data structure analyzer 20 (as described with reference to FIGS. 2A and 2B).

As shown in step S1010, the at least one processor (e.g., processor 2 of FIG. 1) may perform receiving of a detection rule (e.g., detection rule 40A), representing a known cyber vulnerability (e.g., known cyber vulnerability 40A1) associated with a specific data structure type (e.g., data structure type 20A1, defined by data structure type information 20A). Step S1010 may be carried out by detection rule converter 30 and vulnerability detection module 90 (as described with reference to FIGS. 2A and 2B).

As shown in step S1015, the at least one processor (e.g., processor 2 of FIG. 1) may perform parsing of the detection rule (e.g., detection rule 40A), to produce a generic representation (e.g., generic representation 30A) of the detection rule. Step S1015 may be carried out by detection rule converter 30 (as described with reference to FIGS. 2A and 2B).

As shown in step S1020, the at least one processor (e.g., processor 2 of FIG. 1) may perform creation of a disarm rule (e.g., disarm rule 50A) for mitigating the cyber vulnerability (e.g. cyber vulnerability 40A1) in incoming data structures (e.g., in data structure 10A from input queue 11A) of the specific data structure type (e.g., data structure type 20A1, defined by data structure type information 20A), based on the generic representation (e.g., generic representation 30A) and the specific data structure type (e.g., data structure type 20A1). Said disarm rule (e.g., disarm rule 50A) comprises an association between (a) an instantiation of the known cyber vulnerability in the data structure of the specific data structure type (e.g., instantiation 50A1 of known cyber vulnerability 40A1 in data structure 10A of specific data structure type 20A1), and (b) at least one omission action (e.g., omission action 50A2), required for omitting at least one portion of the data structure (e.g., portion 10A1 of data structure 10A), wherein said portion comprises the known cyber vulnerability. Step S1020 may be carried out by disarm rule generation module 50 (as described with reference to FIGS. 2A and 2B).

As shown in step S1025, the at least one processor (e.g., processor 2 of FIG. 1) may perform creation of a reconstruction rule (e.g., reconstruction rule 70A) based on the generic representation (e.g., generic representation 30A) and the specific data structure type (e.g., data structure type 20A1, defined by data structure type information 20A). Said reconstruction rule (e.g., reconstruction rule 70A) comprises an association between (a) a location of the instantiation of the known cyber vulnerability in the data structure of the specific data structure type (e.g., location 70A1 of instantiation 50A1 of known cyber vulnerability 40A1 in data structure 10A of specific data structure type 20A1), and (b) at least one reconstruction action (e.g., reconstruction action 70A2), required for maintaining a predefined functionality of the data structure (e.g., data structure 10A) following omission of the known cyber vulnerability (e.g., known cyber vulnerability 40A1) from the data structure (e.g., data structure 10A). Step S1025 may be carried out by reconstruction rule generation module 70 (as described with reference to FIGS. 2A and 2B).

As shown in step S1030, the at least one processor (e.g., processor 2 of FIG. 1) may perform applying of the omission action (e.g., omission action 50A2) on the target data structure (e.g., data structure 10A), to omit said portion (e.g., portion 10A1), thus obtaining a disarmed data structure (e.g., disarmed data structure 60A). Step S1030 may be carried out by content disarm module 60 (as described with reference to FIGS. 2A and 2B).

As shown in step S1035, the at least one processor (e.g., processor 2 of FIG. 1) may perform applying of the reconstruction action (e.g., reconstruction action 70A2) on the disarmed data structure (e.g., disarmed data structure 60A), to maintain the predefined functionality of the target data structure (e.g., data structure 10A). Step S1035 may be carried out by content reconstruction module 80 (as described with reference to FIGS. 2A and 2B).

Referring now to FIG. 3B, a flow diagram is presented, depicting a method of mitigating cyber vulnerabilities, by at least one processor, according to alternative embodiments.

As shown in step S2005, the at least one processor (e.g., processor 2 of FIG. 1) may perform receiving a target data structure (e.g., input data structure 10A) of a specific data structure type (e.g., data structure type 20A1). Step S2005 may be carried out by data structure analyzer 20 (as described with reference to FIGS. 2A and 2B).

As shown in step S2010, the at least one processor (e.g., processor 2 of FIG. 1) may perform receiving a detection rule (e.g., detection rule 40A), representing a known cyber vulnerability (e.g., known cyber vulnerability 40A1) associated with the specific data structure type (e.g., data structure type 20A1). Step S2010 may be carried out by detection rule converter 30 and vulnerability detection module 90 (as described with reference to FIGS. 2A and 2B).

As shown in step S2015, the at least one processor (e.g., processor 2 of FIG. 1) may perform detecting, based on the detection rule (e.g., detection rule 40A), at least one portion of the target data structure (e.g., portion 10A1 of data structure 10A) that comprises an instantiation of the known cyber vulnerability (e.g., instantiation 50A1 of known cyber vulnerability 40A1). Step S2015 may be carried out by vulnerability detection module 90 (as described with reference to FIGS. 2A and 2B).

As shown in step S2020, the at least one processor (e.g., processor 2 of FIG. 1) may perform creating a detected vulnerability map (e.g., detected vulnerability map 90B) representing an interconnection between the detected portion (e.g., portion 10A1) and at least one section and/or element of the data structure (e.g., section 10A2 and/or element 10A3 of data structure 10A), related to the detected portion. Step S2020 may be carried out by vulnerability detection module 90 (as described with reference to FIGS. 2A and 2B).

As shown in step S2025, the at least one processor (e.g., processor 2 of FIG. 1) may perform applying, based on said detected vulnerability map (e.g., detected vulnerability map 90B), an omission action (e.g., omission action 50A2) on the target data structure (e.g., data structure 10A), to omit the detected portion (e.g., portion 10A1) and the at least one section and/or element (e.g., section 10A2 and/or element 10A3), thus obtaining a disarmed data structure (e.g., disarmed data structure 60A). Step S2025 may be carried out by content disarm module 60 (as described with reference to FIGS. 2A and 2B).

In order to clarify the description of the claimed invention, the following specific non-exclusive example representing performance of the claimed system 10 is provided.

The example is directed to the mitigation of Log4Shell (CVE-2021-44228), which was a newly discovered vulnerability in Log4j, a popular Java logging framework, involving arbitrary code execution.

According to the example, data structure analyzer 20 may receive API module, which includes references to Apache Log4j logging utility functions, as input data structure 10A. For example, this API module may include the following instruction code:

“request”: {
“headers”: {
“accept-language”: “en-US,en;q=0.5”,
“accept-encoding”: “gzip,”,
“x-forwarded-for”: “64.9.8.26”,
“host”: “targetexamplesite[.]com${jndi:ldap://127.0.0.1:6000}”,
“accept”: “text/html,application/xhtml+xml,application/xml;q=0.9,*/*;q=0.8”,
“user-agent”: “Mozilla/6.0”,
“connection”: “keep-alive”,
...
}
...
}

Data structure analyzer 20 may analyze the received API module and form data structure type information 20A about received API module, including information identifying the presence of logging functions, provided by Apache Log4j.

Detection rule converter 30 may further receive data structure type information 20A. Detection rule converter 30 may further request a corresponding detection rule 40A, representing known cyber vulnerability 40A1 (e.g., Log4Shell (CVE-2021-44228)) associated with said data structure type 20A1 (e.g., API module utilizing logging functions of Apache Log4j), defined by data structure type information 20A.

Detection rule 40A dedicated to Log4Shell (CVE-2021-44228) vulnerability 40A1 may include the following instruction code (e.g., instruction code 5):

rule EXPL_Log4j_CVE_2021_44228_Dec21_Soft {
meta:
description = “Detects indicators in server logs that indicate an exploitation attempt of CVE-2021-44228”
author = “Florian Roth”
reference = “https://twitter.com/h113sdx/status/1469010902183661568?s=20”
date = “2021-12-10”
modified = “2021-12-20”
score = 60
type = “file”
strings:
$x01 = “${jndi:ldap:/”
$x02 = “${jndi:rmi:/”
$x03 = “${jndi:ldaps:/”
$x04 = “${jndi:dns:/”
$x05 = “${jndi:iiop:/”
$x06 = “${jndi:http:/”
$x07 = “${jndi:nis:/”
$x08 = “${jndi:nds:/”
$x09 = “${jndi:corba:/”
$fp1 = “<html”
$fp2 = “/nessus}”
condition:
1 of ($x*) and not 1 of ($fp*)
}

The abovementioned detection rule 40A is provided by the GitHub Community.

Detection rule converter 30 may further receive said detection rule 40A.

Detection rule converter 30 may further parse received detection rule 40A and produce generic representation 30A of detection rule. In this simplified example, no specific mapping of language formats and/or syntaxes with respect to data structure type 20A1 is required. Consequently, generic representation 30A will simply include the same instructions (e.g., instruction code 5) as described detection rule 40A. However, it should be understood that in some other cases such syntax mapping and conversion may be required.

Vulnerability detection module 90 may further receive data structure 10A (the described API module) and said detection rule 40A. Vulnerability detection module 90 may apply said detection rule 40A and detect the following portion 10A1: “targetexamplesite[.]com${jndi:ldap://127.0.0.1:6000}”. As can be seen, this portion 10A1 includes the following instantiation 50A1 of respective vulnerability 40A1: “0xe8:$x01: ${jndi:ldap:/”.

Vulnerability detection module 90 may further create detected vulnerability map 90B representing interconnection between said portion 10A1 and at least one section 10A2 and/or element 10A3 of said API module, related to detected portion 10A1. In this particular example, detected vulnerability map 90B may include information indicating that said vulnerability 40A1 is located at object “request.header.host” of said API module.

Disarm rule generation module 50 may further receive data structure type information 20A and generic representation 30A specified above.

Disarm rule generation module 50 may further create disarm rule 50A based on generic representation 30A and data structure type 20A1 specified by received data structure type information 20A. Disarm rule 50A may include an association between (a) instantiation 50A1 of known cyber vulnerability 40A1 (which is “0xe8:$x01:${jndi:ldap:/” in this example), and (b) at least one omission action 50A2. In this case, the omission action 50A2 may include omission of some special characters (e.g., “?”, “$”) that are related to the detected portion 10A1. Hence, omission action 50A2 may include the following instructions:

{“adjactent_special_characters”:[“?”,”$”,”&”],
“adjactent_special_characters_to_remove”: True,
“remove_adjactent_key”:true,
}.

Content disarm module 60 may further receive data structure 10A (e.g., said API module), said disarm rule 50A and detected vulnerability map 90B.

Content disarm module 60 may further apply, based on said detected vulnerability map 90B, omission action 50A2 of disarm rule 50A on said API module, to omit the determined sufficient amount of data. In this example, content disarm module 60 may apply the following instructions:

“generated_disarm_rule”:” {jndi:ldap://127.0.0.1:6000}″
{“host”:
{“adjactent_special_characters”:[“?”,”$”,”&”],
“adjactent_special_characters_to_remove”: True,
“remove_adjactent_key”:true,
}
“referer”:{..},
“connection”:{..}.
...
...
}

Content disarm module 60 may further output respectively disarmed data structure 60A. In this example, disarmed data structure 60A may have the same instructions as the API module except for the portion 10A1 which, after the omission, may be the following: “host”:“targetexamplesite[.]com.

Reconstruction rule generation module 70 may further receive said data structure type information 20A and generic representation 30A. Reconstruction rule generation module 70 may further create reconstruction rule 70A. Reconstruction rule 70A may include an association between (a) location 70A1 of instantiation 50A1 of known cyber vulnerability 40A1 in said API module (which is object “request.header”, according to the example), and (b) reconstruction action 70A2, required for maintaining a predefined functionality of the API module following omission of cyber vulnerability 40A1 from it. In the described simplified example, reconstruction action 70A2 may either be skipped or, for instance, include substitution of the initially indicated host address (//127.0.0.1:6000) by the predefined template. As a result, reconstruction rule 70A may include the following instructions:

{“host”: {“replace_to_template”: True,
“template”: “Ariel.ac.il/alert.html”,
“only_disarm”:False,
..
..
},
“referer”:{ }.
“connection”:{ }..
}

Finally, reconstructed data structure 80A (reconstructed API module) may include the following amendments to the portion 10A1: “host”:“Ariel.ac.il/alert.html”.

As it can be seen from the provided description, the claimed invention represents a system and method having a practical application of mitigating cyber vulnerabilities. Embodiments of the invention may improve computer technology by providing a technical effect of increasing protection against cyberattacks. In particular, the claimed invention represents a computer security solution which provides more vulnerability-specific protection than conventional CDR solutions on the one hand and more time-critical protection than conventional malware-analysis-based solutions on the other hand.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of mitigating cyber vulnerabilities by at least one processor, the method comprising:
receiving a detection rule, representing a known cyber vulnerability associated with a specific data structure type;
parsing the detection rule, to produce a generic representation of the detection rule; and
based on the generic representation and the specific data structure type, creating a disarm rule for mitigating the cyber vulnerability in incoming data structures of the specific data structure type.

2. The method of claim 1, wherein said disarm rule comprises an association between (a) an instantiation of the known cyber vulnerability in a data structure of the specific data structure type, and (b) at least one omission action, required for omitting at least one portion of the data structure, wherein said portion comprises the known cyber vulnerability.

3. The method of claim 2, further comprising:
receiving a target data structure of the specific data structure type; and
applying the omission action on the target data structure, to omit the at least one portion of the target data structure that comprises the known cyber vulnerability, thus obtaining a disarmed data structure.

4. The method of claim 2, further comprising:
receiving a target data structure of the specific data structure type;
applying the detection rule, to detect at least one portion of the target data structure that comprises the instantiation of the known cyber vulnerability;
creating a detected vulnerability map representing an interconnection between the detected portion and at least one section and/or element of the data structure, related to the detected portion; and
based on said detected vulnerability map, applying the omission action on the target data structure, to omit the detected portion, thus obtaining a disarmed data structure.

5. The method of claim 4, wherein the omission action is further selected from: omission of at least one section of the data structure, related to the detected portion; omission of at least one element of the data structure, related to the detected portion; and omission of at least one reference to said section or element.

6. The method of claim 3, further comprising creating a reconstruction rule based on the generic representation and the specific data structure type, wherein said reconstruction rule comprises an association between (a) location of an instantiation of the known cyber vulnerability in a data structure of the specific data structure type, and (b) at least one reconstruction action, required for maintaining a predefined functionality of the data structure following omission of the known cyber vulnerability from the data structure.

7. The method of claim 6, further comprising applying the reconstruction action on the disarmed data structure, to maintain the predefined functionality of the target data structure.

8. The method of claim 1, wherein the data structure is selected from a list consisting of: a file, a data stream, a string representing an Application Programming Interface (API) request, and a string representing an API response.

9. The method of claim 1, wherein the detection rule is of a first type of a plurality of detection rule types, and wherein parsing the detection rule, comprises producing the generic representation that has a format common to (i) the first type and (ii) at least one second type of the plurality of detection rule types.

10. A method of mitigating cyber vulnerabilities by at least one processor, the method comprising:
receiving a target data structure of a specific data structure type;
receiving a detection rule, representing a known cyber vulnerability associated with the specific data structure type;
based on the detection rule, detecting at least one portion of the target data structure that comprises an instantiation of the known cyber vulnerability;
creating a detected vulnerability map representing an interconnection between the detected portion and at least one section and/or element of the data structure, related to the detected portion;
based on said detected vulnerability map, applying an omission action on the target data structure, to omit the detected portion and the at least one section and/or element, thus obtaining a disarmed data structure.

11. A system for mitigating cyber vulnerabilities, the system comprising: a non-transitory memory device, wherein modules of instruction code are stored, and at least one processor associated with the memory device, and configured to execute the modules of instruction code, whereupon execution of said modules of instruction code, the at least one processor is configured to:
receive a detection rule, representing a known cyber vulnerability associated with a specific data structure type;
parse the detection rule, to produce a generic representation of the detection rule; and
based on the generic representation and the specific data structure type, create a disarm rule for mitigating the cyber vulnerability in incoming data structures of the specific data structure type.

12. The system of claim 11, wherein said disarm rule comprises an association between (a) an instantiation of the known cyber vulnerability in a data structure of the specific data structure type, and (b) at least one omission action, required for omitting at least one portion of the data structure, wherein said portion comprises the known cyber vulnerability.

13. The system of claim 12, wherein the at least one processor is further configured to:
receive a target data structure of the specific data structure type; and
apply the omission action on the target data structure, to omit the at least one portion of the target data structure that comprises the known cyber vulnerability, thus obtaining a disarmed data structure.

14. The system of claim 12, wherein the at least one processor is further configured to:
receive a target data structure of the specific data structure type;
apply the detection rule, to detect at least one portion of the target data structure that comprises the instantiation of the known cyber vulnerability;
create a detected vulnerability map representing an interconnection between the detected portion and at least one section and/or element of the data structure, related to the detected portion; and
based on said detected vulnerability map, apply the omission action on the target data structure, to omit the detected portion, thus obtaining a disarmed data structure.

15. The system of claim 14, wherein the omission action is further selected from: omission of at least one section of the data structure, related to the detected portion; omission of at least one element of the data structure, related to the detected portion; and omission of at least one reference to said section or element.

16. The system of claim 13, wherein the at least one processor is further configured to create a reconstruction rule based on the generic representation and the specific data structure type, and wherein said reconstruction rule comprises an association between (a) location of an instantiation of the known cyber vulnerability in a data structure of the specific data structure type, and (b) at least one reconstruction action, required for maintaining a predefined functionality of the data structure following omission of the known cyber vulnerability from the data structure.

17. The system of claim 16, wherein the at least one processor is further configured to apply the reconstruction action on the disarmed data structure, to maintain the predefined functionality of the target data structure.

18. The system of claim 11, wherein the data structure is selected from a list consisting of: a file, a data stream, a string representing an API request, and a string representing an API response.

19. The system of claim 11, wherein the detection rule is of a first type of a plurality of detection rule types, and wherein the at least one processor is configured to parse the detection rule by producing the generic representation that has a format common to (i) the first type and (ii) at least one second type of the plurality of detection rule types.
